(19) United States
(12) Patent Application Publication
(10) Pub. No.: US 2026/0121355 A1
(43) Pub. Date: Apr. 30, 2026

(54) CONTACT ASSEMBLY OF AN ELECTRICAL CONNECTOR HAVING UPPER AND LOWER GROUND PLATES

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: Terrance F. Little, Fullerton, CA (US); Jesse Li, Anaheim, CA (US); Yi-Min Hsu, New Taipei (TW)

(21) Appl. No.: 19/364,032

(22) Filed: Oct. 21, 2025

Related U.S. Application Data
(60) Provisional application No. 63/711,475, filed on Oct. 24, 2024.

(51) Int. Cl. H01R 13/6585; H01R 12/71; H01R 13/6597

(52) U.S. Cl. CPC H01R 13/6585; H01R 12/716; H01R 13/6597

(57) ABSTRACT

A contact assembly for an electrical connector includes: a row of signal contacts having plural contacting portions and plural mounting portions; an insulator secured to the row of signal contacts; and an upper ground plate and a lower ground plate surrounding the row of signal contacts; wherein each of the upper ground plate and the lower ground plate integrally has plural ground mounting portions; and the plural ground mounting portions of one of the upper ground plate and the lower ground plate contact the other one of the upper ground plate and the lower ground plate, and the plural ground mounting portions of the other one of the upper ground plate and the lower ground plate are aligned with the plural mounting portions of the row of signal contacts.

### CROSS REFERENCE TO RELATED APPLICATION

This application claims priority to and benefit of U.S. Provisional Patent Application No. 63/711,475, filed Oct. 24, 2024.

### BACKGROUND OF THE INVENTION

### Field of the Invention

The present invention relates to a contact assembly for an electrical connector comprising: a row of signal contacts having a plurality of contacting portions and a plurality of mounting portions; an insulator secured to the row of signal contacts; and upper and lower ground plates with a plurality of ground contacting portions aligned with the plurality of contacting portions of the row of signal contacts, wherein the upper and lower ground plates are designed for improved signal integrity.

### Description of Related Arts

U.S. Patent Application Publication No. 2021/0328384 discloses a conductive ground shield which may be plural split-shields or a single piece. Also disclosed is combining the conductive ground shield and metal ground conductors, as seen in drawing FIG. 3L thereof.

U.S. Patent Application Publication No. 2022/0352675 discloses a lead frame assembly. The corrugated sheets may be provided on a top surface, a bottom surface, or both the top and bottom surfaces of the lead frame assembly. The corrugated sheet electrically couples ground conductors and may be made of material that is electrically conductive or lossy. Electrically lossy materials typically have a bulk conductivity of about 1 to 100,000 Siemen/meter.

U.S. Pat. No. 11,322,869 discloses a contact assembly for an electrical connector, comprising: a contact array including signal contacts and ground contacts having mating beams and tails; a front contact holder holding the mating beams and a rear contact holder holding the tails; and a ground bus bridge extending between each of the ground contacts to electrically common each of the ground contacts. The ground bus bridge is integral with the ground contacts and includes a plate at ground intermediate portions. The plate of the ground bus bridge extends across signal intermediate portions, i.e., parallel thereto, spaced apart therefrom, and in close proximity thereto, for resonance control of signals transmitted along the signal contacts.

U.S. Pat. No. 11,469,554 discloses a leadframe assembly including conductive elements, a leadframe housing holding the conductive elements, and a ground shield separate from intermediate portions of the conductive elements by the leadframe housing. The ground shield may be stamped from a sheet of metal and may have a right angle bend. The ground shield may be attached to housing portions. The ground shield may include a body, ground mating ends extending from the body, and ground mounting ends also extending from the body.

U.S. Patent Application Publication No. 2014/0127946 discloses a receptacle connector including a housing, plural first row contacts, plural second row contacts, plural first conductive members, and plural second conductive members. The conductive members are made of a conductive resin for electrically connecting plural ground contacts of the row of contacts. The conductive member has a base portion and a projection. The conductive members may be connected to each other, i.e., integrated together, when a long and thin metal plate is inserted thereinto, so as to have flexibility in handling.

U.S. Patent Application Publication No. 2024/0097374 discloses a receptacle assembly, a cage, and a mounting method in connection with VLC (Vertical Line Card) applications.

### SUMMARY OF THE INVENTION

A contact assembly for an electrical connector comprises: a row of signal contacts having plural contacting portions and plural mounting portions; an insulator secured to the row of signal contacts; and an upper ground plate and a lower ground plate surrounding the row of signal contacts, at least one of the upper ground plate and the lower ground plate integrally forming plural ground contacting portions aligned with the plural contacting portions of the row of signal contacts; wherein each of the upper ground plate and the lower ground plate integrally has a plurality of ground mounting portions; and the plurality of ground mounting portions of one of the upper ground plate and the lower ground plate contact the other one of the upper ground plate and the lower ground plate, and the plurality ground mounting portions of the other one of the upper ground plate and the lower ground plate are aligned with the plurality of mounting portions of the row of signal contacts.

### BRIEF DESCRIPTION OF DRAWINGS

FIG. 1 is a perspective view of an electrical connector incorporating contact assemblies in accordance with the present invention;

FIG. 2 is another perspective view of the electrical connector;

FIG. 3 is an exploded view of the electrical connector;

FIG. 4 is another exploded view of the electrical connector;

FIG. 5 is a perspective view of the contact assemblies;

FIG. 6 is an exploded view of the contact assemblies;

FIG. 7 is another exploded view of the contact assemblies;

FIG. 8 is a further exploded view of an upper contact assembly;

FIG. 9 is a further exploded view of a lower contact assembly;

FIG. 10 is a view similar to FIG. 6 but omitting an insulator;

FIG. 11 is a cross-sectional view taken along line A-A in FIG. 1;

FIG. 12 is a cross-sectional view taken along line B-B in FIG. 1;

FIG. 13 is a bottom perspective view of an electrical connector incorporating varied contact assemblies in accordance with the present invention;

FIG. 14 is a view similar to FIG. 10 showing a varied upper contact assembly of the electrical connector in FIG. 13;

FIG. 15 is a view similar to FIG. 14 but showing a varied lower contact assembly;

FIG. 16 is a cross-sectional view taken along line C-C in FIG. 13;

FIG. 17 is a perspective view of a varied electrical connector incorporating contact assemblies in accordance with the present invention;

FIG. 18 is an exploded view of the varied electrical connector;

FIG. 19 depicts a varied ground plate;

FIG. 20 depicts another varied contact assembly;

FIG. 21 is a perspective view of another varied electrical connector incorporating contact assemblies in accordance with the present invention;

FIG. 22 is an exploded view of FIG. 21;

FIG. 23 is a further exploded view of FIG. 22;

FIG. 24 shows another application of use for yet another varied electrical connector incorporating contact assemblies in accordance with the present invention;

FIG. 25 is an exploded view of FIG. 24;

FIG. 26 is an exploded view of the electrical connector in FIG. 24;

FIG. 27 is a schematic view of signal contacts and ground plates of the electrical connector in FIG. 24;

FIG. 28 is a view similar to FIG. 18, but showing still another varied electrical connector;

FIG. 29 is an exploded view of a contact assembly of the varied electrical connector in FIG. 28;

FIG. 30 is an enlarged assembled view of a portion of the contact assembly in FIG. 29; and

FIG. 31 depicts yet another varied ground plate.

### DETAILED DESCRIPTION OF THE DRAWINGS

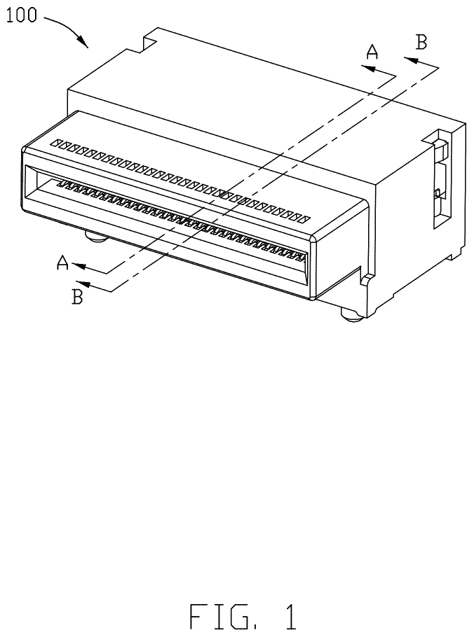

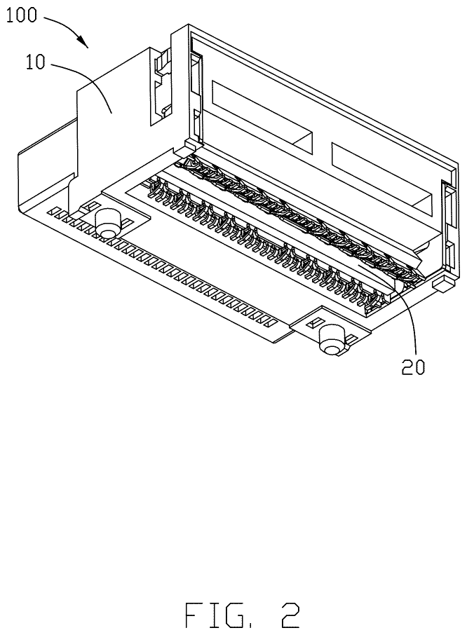

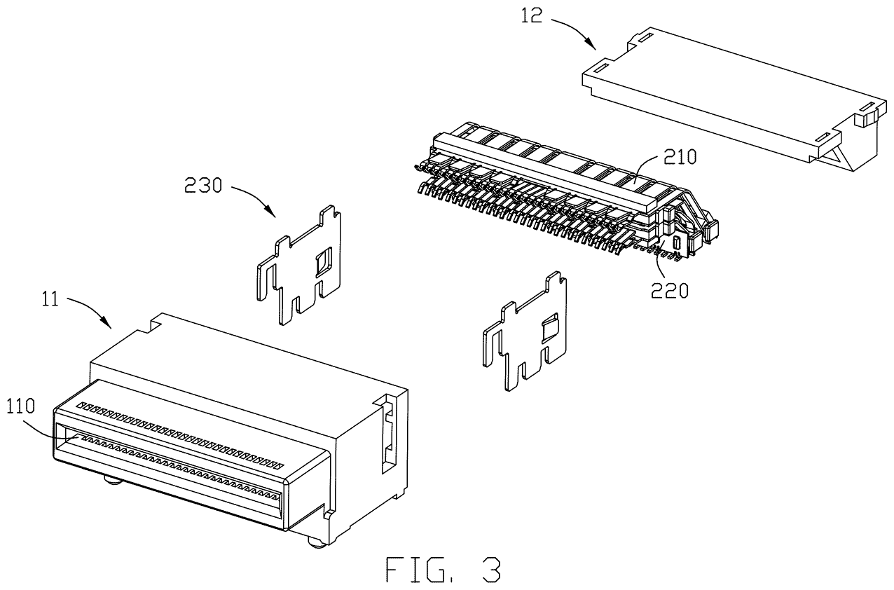

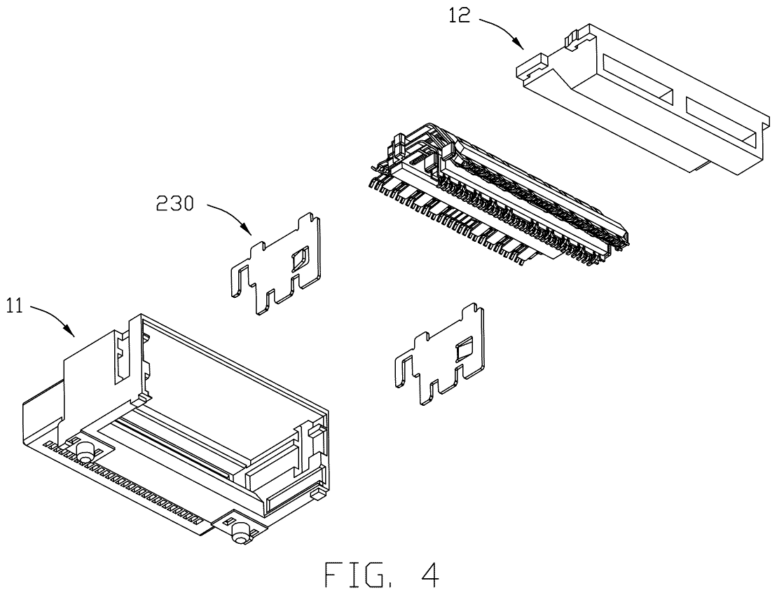

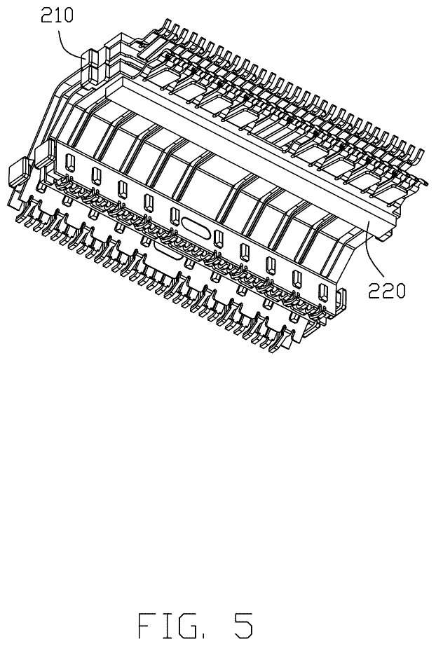

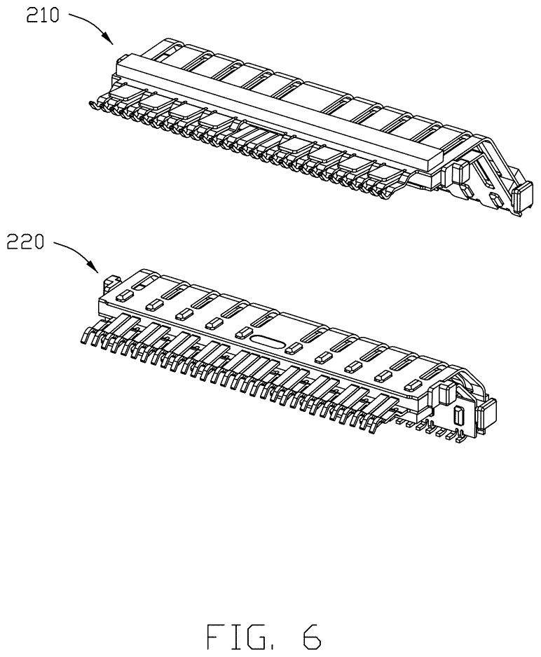

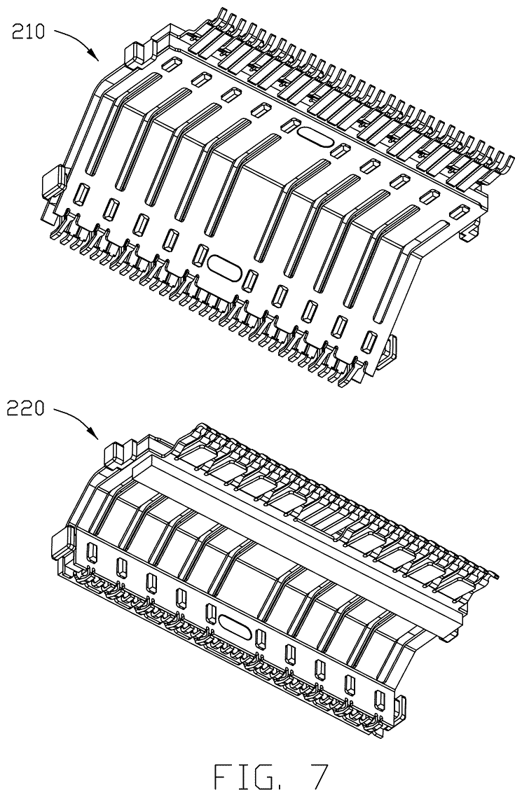

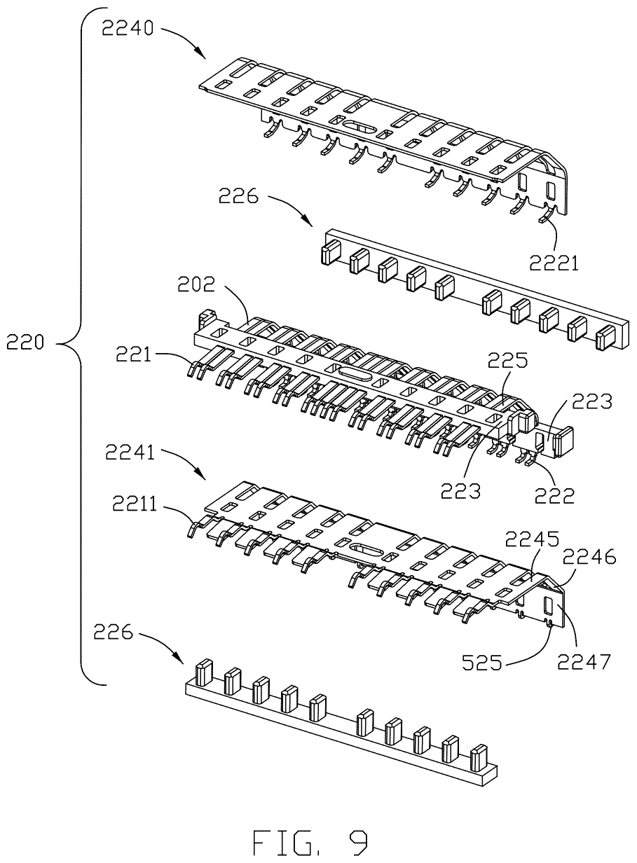

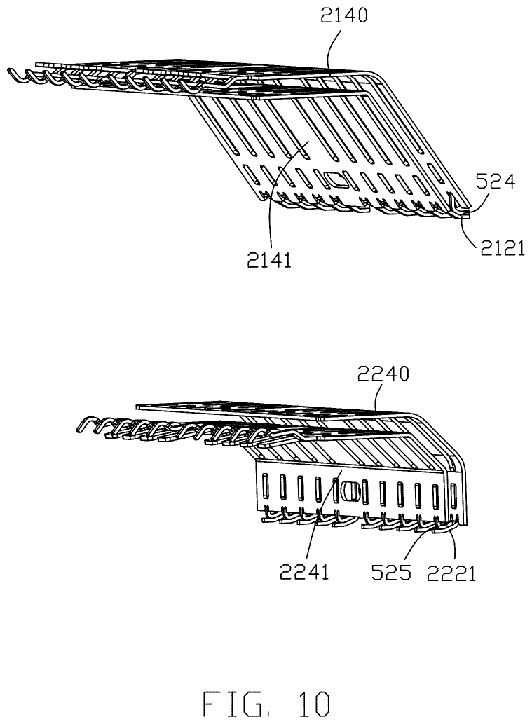

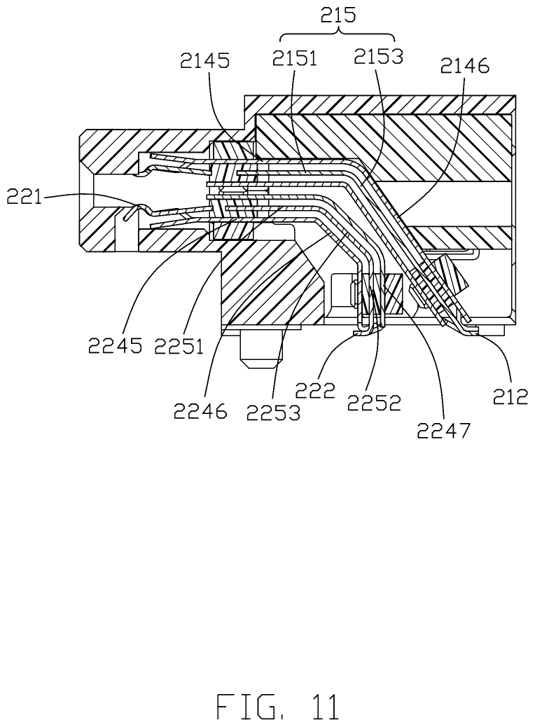

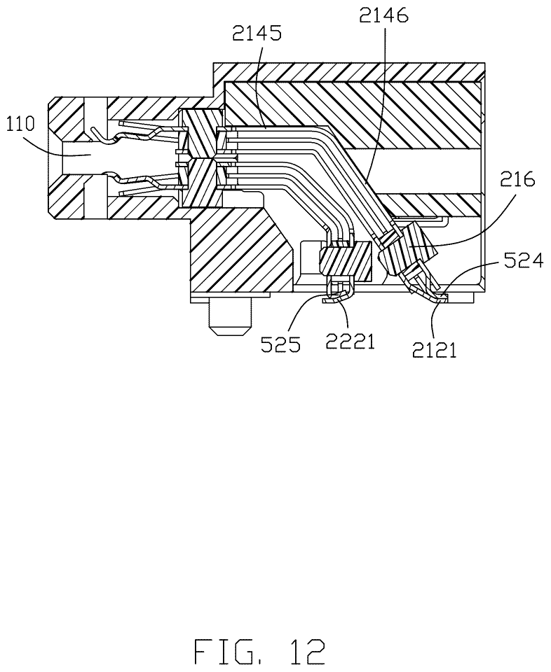

Referring to FIGS. 1-12, an electrical connector 100 comprises an insulative housing 10 and a contact module 20 in the insulative housing 10. The insulative housing 10 includes a main body 11 and a cover 12. The main body 11 has a port 110. The contact module 20 in the embodiment shown includes an upper assembly 210, a lower assembly 220, and a pair of side plates 230 for assembling the upper and lower assemblies 210 and 220.

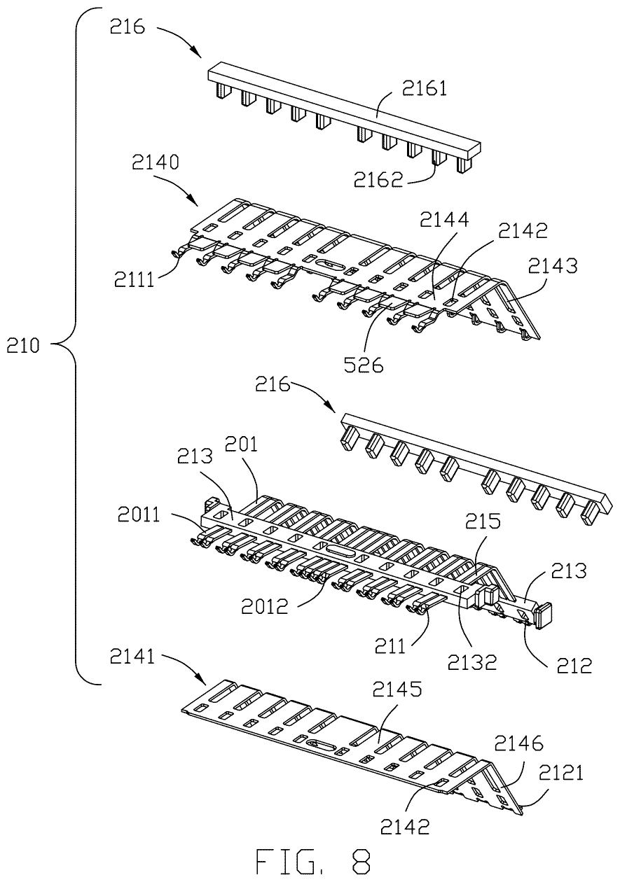

Referring specifically to FIG. 8, the upper assembly 210 includes a row of contacts 201, an insulator 213 secured to the row of contacts 201, an upper ground plate 2140 and a lower ground plate 2141 that surround the row of contacts 201, and a conductive element 216 electrically connecting the upper and lower ground plates 2140 and 2141. The row of contacts 201 includes signal contacts 2011 for differential pair signals and side-band contacts 2012 for ground signals, control, power, and/or low-speed signals. Each of the contacts 201 has a contacting portion 211, a mounting portion 212, and an intermediate portion 215 between the contacting portion 211 and the mounting portion 212. The intermediate portion 215 may include a horizontal section 2151 and an inclined section 2153.

The upper ground plate 2140 and the lower ground plate 2141 are equidistantly spaced from and surround the row of contacts 201 to form a strip-line structure for achieving a better high speed transmission performance, like a PCB style design. Each of the upper ground plate 2140 and the lower ground plate 2141 may be a single piece or be constructed of multiple pieces, and have a horizontal portion 2145 and an inclined portion 2146. Each ground plate 2140 or 2141 has a plurality of openings 2143 for air circulation and plural covering portions 2144 interposed between adjacent openings 2143. Each of the covering portions 2144 is aligned with a corresponding pair of signal contacts 2011.

The upper ground plate 2140 may integrally form a plurality of ground contacting portions 2111 and a plurality of ground mounting portions 524. Each of the ground contacting portions 2111 and the ground mounting portions 524 is located beside or between corresponding pairs of signal contacts 2011. The lower ground plate 2141 may integrally form a plurality of ground mounting portions 2121. The plurality of ground mounting portions 524 of the upper ground plate 2140 contact the plurality of ground mounting portions 2121 of the lower ground plate 2141. As can be understood, similar ground contacting portions and/or ground mounting portions may equally well be formed on the lower ground plate 2141, or the upper ground plate 2140 may form some of the plurality of ground contacting portions or ground mounting portions while the lower ground plate 2141 may form the remaining ground contacting portions or ground mounting portions. The ground plate 2140 or 2141 may further include an overhanging feature for impedance control, such as front extensions 526 each situated between every two neighboring ground contacting portions 2111.

The insulator 213 extends transversely and in this embodiment shown there are two pieces of insulators. The insulator 213 has two opposite positioning ends for engaging with corresponding mounting holes of the pair of side plates 230. If desired, the positioning ends may be heat staked after securement in the mounting holes. The conductive element 216 may be made of metals or other conductive materials. The conductive element 216 may be separately made and then mounted to the ground plates 2140 and 2141 or formed in situ, e.g., molded from conductive plastic material. The insulator 213 has holes 2132 and the ground plates 2140 and 2141 have holes 2142 aligned with the holes 2132. The conductive element 216 has a base 2161 and a plurality of extensions 2162 entering the holes 2142 of the upper ground plate 2140, the holes 2132 of the insulator 213, and the holes 2142 of the lower ground plate 2141. The free end of the extension 2162 may extend beyond the lower ground plate 2141 and be heat staked.

The lower assembly 220 may be similarly structured as the upper assembly 210, e.g., to have a row of contacts 202, an insulator 223 secured to the row of contacts 202, an upper ground plate 2240 and a lower ground plate 2241, and one or more conductive elements 226 electrically connecting the upper and lower ground plates 2240 and 2241. Each of the row of contacts 202 has a contacting portion 221, a mounting portion 222, and an intermediate portion 225 therebetween. The intermediate portion 225 may include a horizontal section 2251, a vertical section 2252, and an intermediate inclined section 2253. Each of the upper ground plate 2240 and the lower ground plate 2241 may have a horizontal portion 2245, a vertical portion 2247, and an intermediate inclined portion 2246. The upper ground plate 2240 may integrally form a plurality of ground mounting portions 2221; the lower ground plate 2241 may integrally form a plurality of ground contacting portions 2211 and a plurality of ground mounting portions 525. The plurality of ground mounting portions 525 of the lower ground plate 2241 contact the plurality of ground mounting portions 2221 of the upper ground plate 2240.

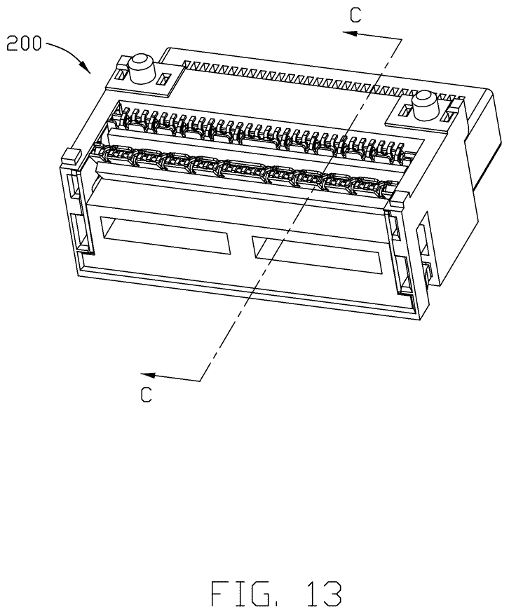

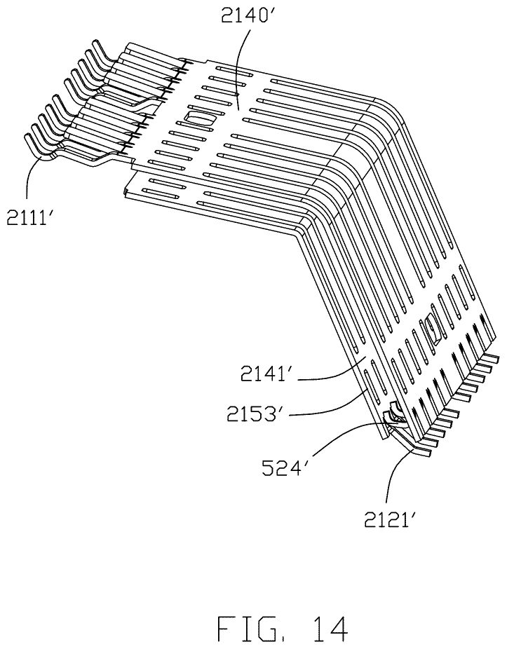

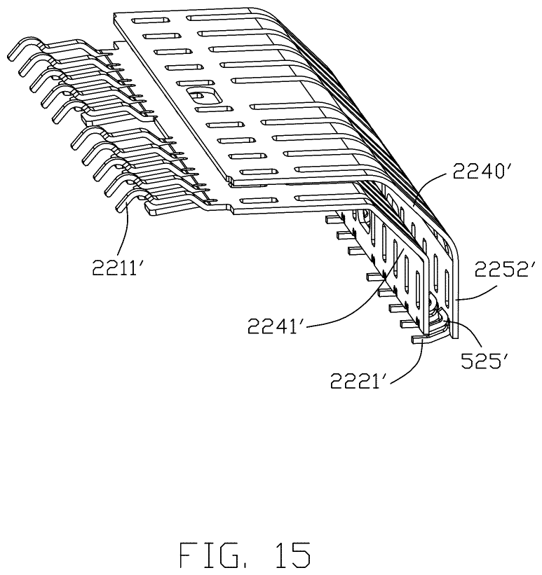

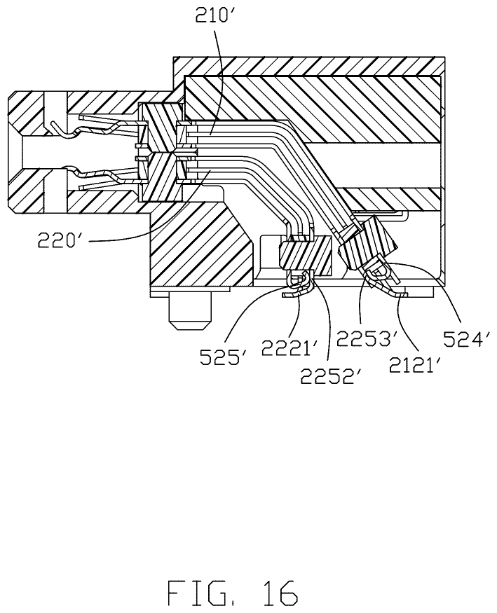

FIGS. 13-16 show an electrical connector 200 incorporating varied contact assemblies. A varied contact assembly may comprise an upper assembly which includes a row of contacts 210′, an insulator secured to the row of contacts 210′, an upper ground plate 2140′, and a lower ground plate 2141′ and a lower assembly which includes a row of contacts 220′, an insulator secured to the row of contacts 220′, an upper ground plate 2240′, and a lower ground plate 2241′. The upper ground plate 2140′ may integrally form a plurality of ground contacting portions 2111′ and a plurality of ground mounting portions 524′; the lower ground plate 2141′ may integrally form a plurality of ground mounting portions 2121′. The plurality of ground mounting portions 524′ of the upper ground plate 2140′ contacts an inclined section 2153′ of the lower ground plate 2141′. The upper ground plate 2240′ may integrally form a plurality of ground mounting portions 2221′; the lower ground plate 2241′ may integrally form a plurality of ground contacting portions 2211′ and a plurality of ground mounting portions 525′. The plurality of ground mounting portions 525′ of the lower ground plate 2241′ contacts a vertical section 2252′ of the upper ground plate 2240′.

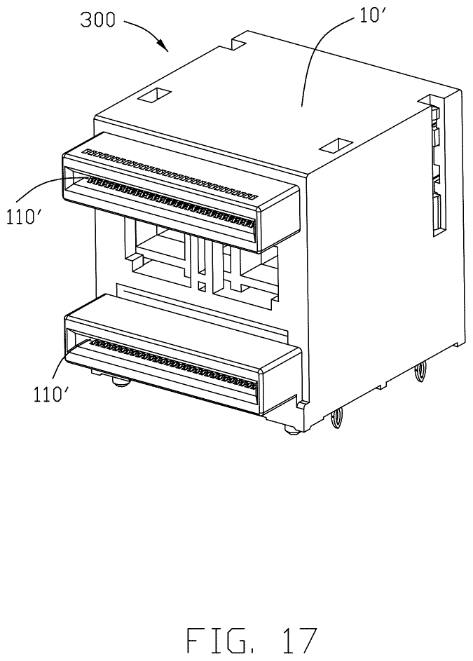

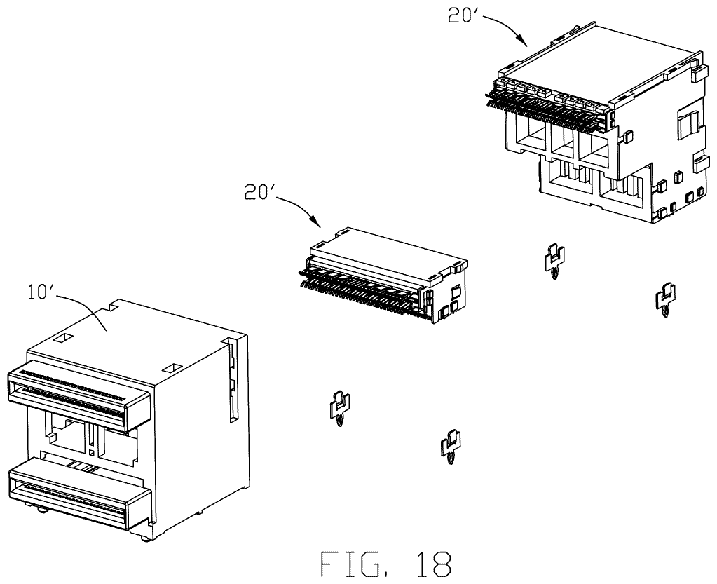

FIGS. 17 and 18 show a varied electrical connector 300 incorporating contact assemblies of the present invention. The electrical connector 300 comprises an insulative housing 10′ and upper and lower contact modules 20′ in the insulative housing 10′. The insulative housing 10′ has upper and lower ports 110′. Each contact module 20′ may include an upper assembly and a lower assembly designed in a similar way to those described above with reference to FIGS. 1-16.

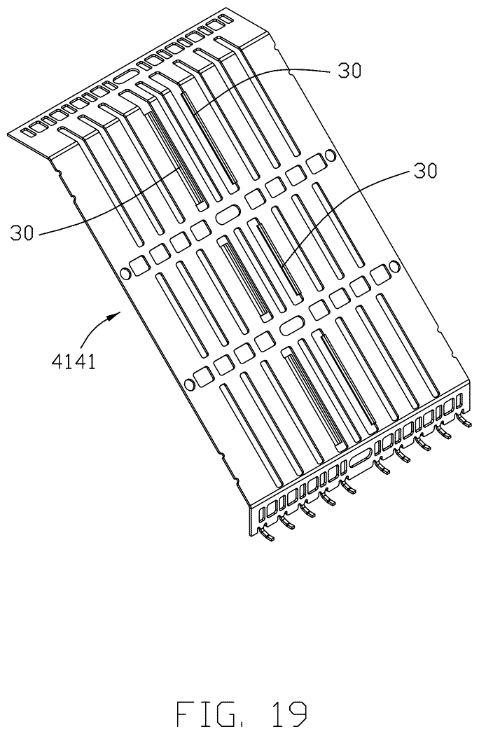

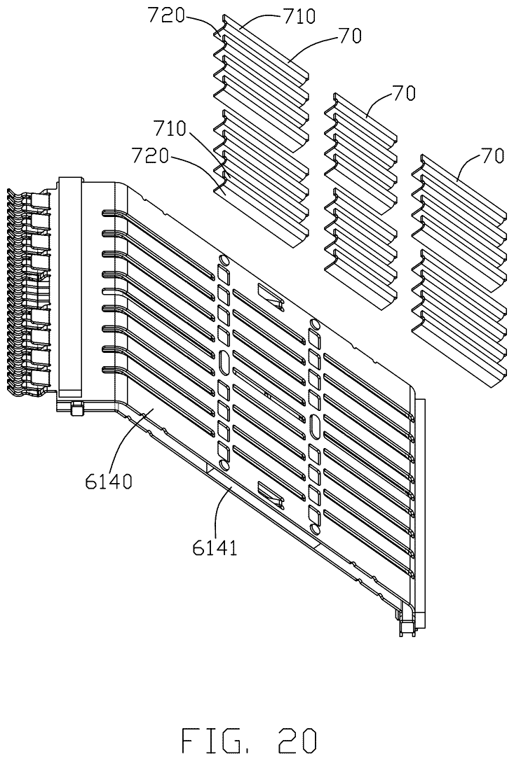

FIG. 19 shows a varied lower ground plate 4141 which integrally forms a plurality of shields 30 bent upward. The shield 30 may be located between low-speed side-band contacts and high-speed differential signal contacts. FIG. 20 shows a varied upper assembly including an upper ground plate 6140 and a lower ground plate 6141. The upper ground plate 6140 may have plural shields 70 separately formed and then attached thereto instead of being integrally formed. Each shield 70 may have a first portion 710 secured to a body of the upper ground plate 6140, and a second portion 720 located between side-band contacts and differential signal contacts or between two adjacent pairs of differential signal contacts.

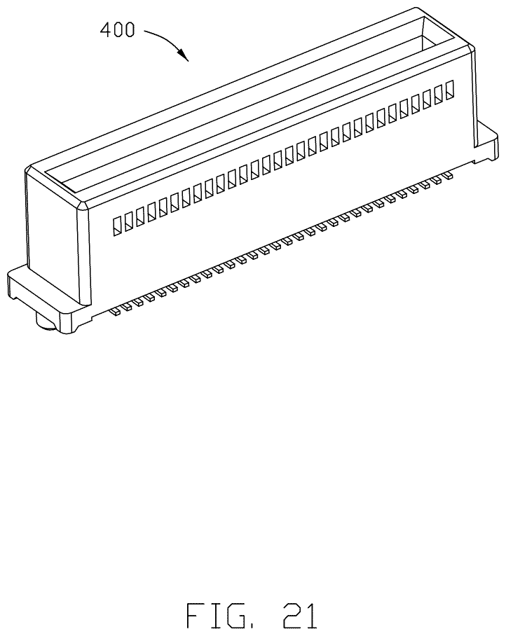

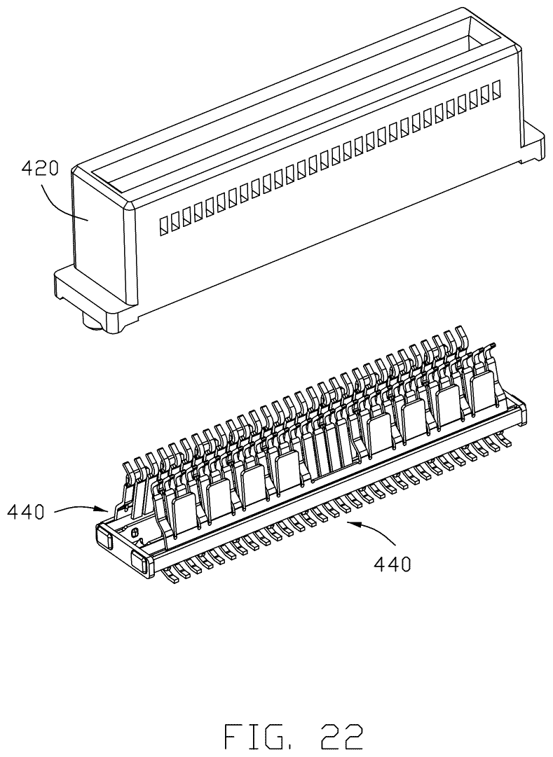

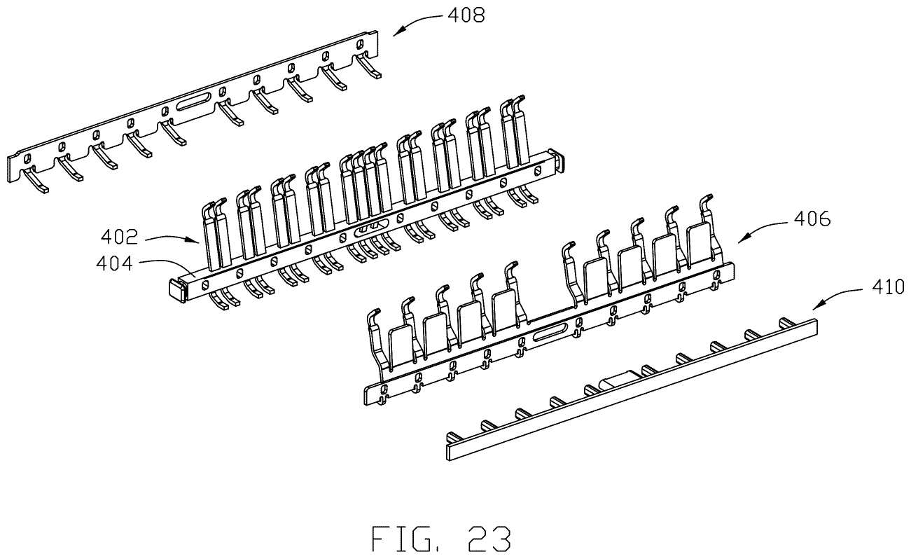

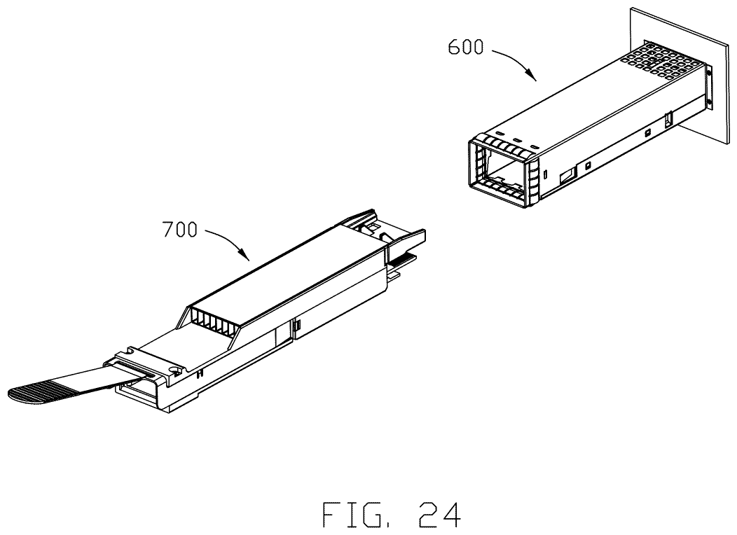

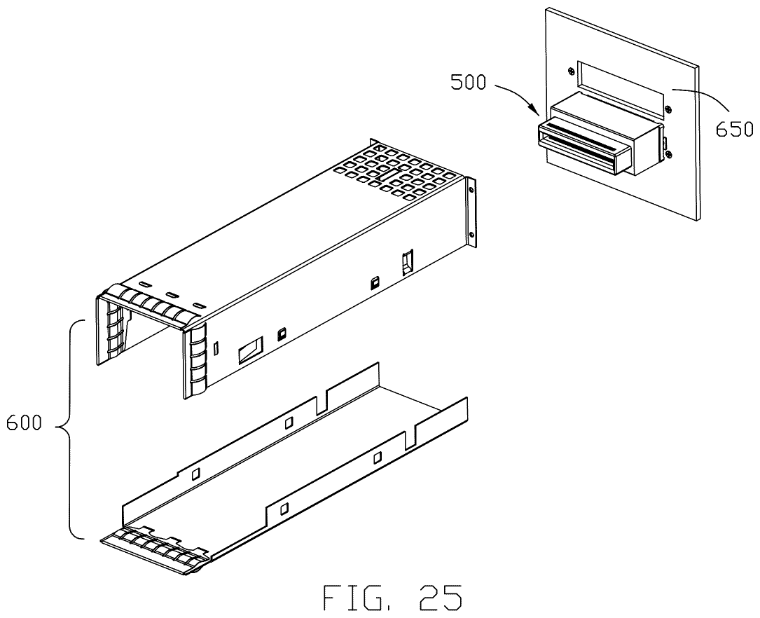

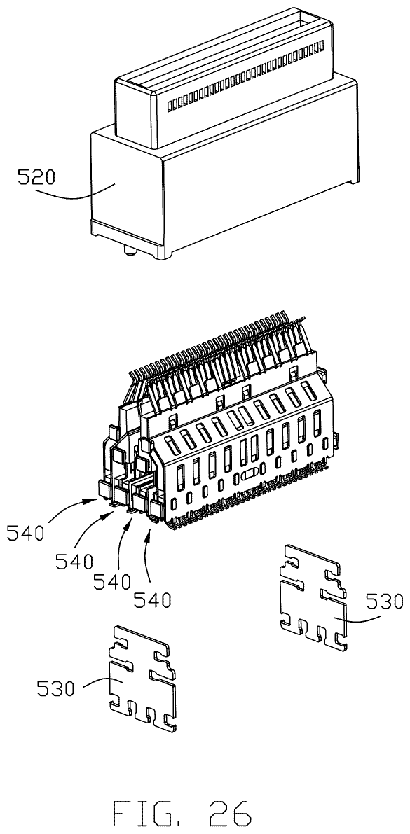

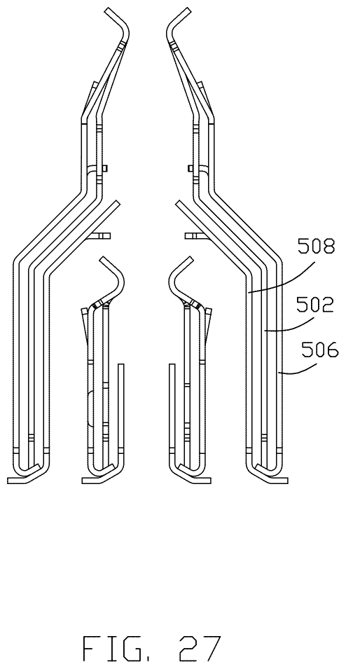

FIGS. 21-23 show another varied electrical connector 400 and FIGS. 24-27 show yet another varied electrical connector 500 incorporating respective contact assemblies of the present invention in applications of VLC (Vertical Line Card) in contrast to traditional horizontal line card where right-angle connector geometry is seen. The electrical connector 400 comprises an insulative housing 420 and a pair of assemblies 440. Each assembly 440 may include a row of contacts 402 secured together by an insulator 404, an outer ground plate 406 and an inner ground plate 408 that surround the row of contacts 201, and a conductive element 410 having portions extending through the outer ground plate 406, the insulator 404, and the inner ground plate 408. The outer ground plate 406 and the inner ground plate 408 may suitably contact each other by way of plural ground mounting portions of one of the outer ground plate 406 and the inner ground plate 408 contacting the other ground plate 406 or 408. The electrical connector 500 are enclosed by a cage 600, of which both are to be mounted to a printed circuit board 650, for receiving a mating pluggable module 700. The electrical connector 500 may comprise an insulative housing 520 and four assemblies 540 mounted to the insulative housing 520, wherein the four assemblies 540 may be arranged in a well known manner and secured together by a pair of side plates 530. Similarly, each assembly 540 may include a row of contacts 502 secured together by an insulator, an outer ground plate 506 and an inner ground plate 508 that surround the row of contacts 201, and a conductive element having portions extending through the outer ground plate 506, the associated insulator, and the inner ground plate 508; the outer ground plate 506 and the inner ground plate 508 may suitably contact each other, e.g., by way of plural ground mounting portions of one of the outer ground plate 506 and the inner ground plate 508 contacting the other ground plate 506 or 508.

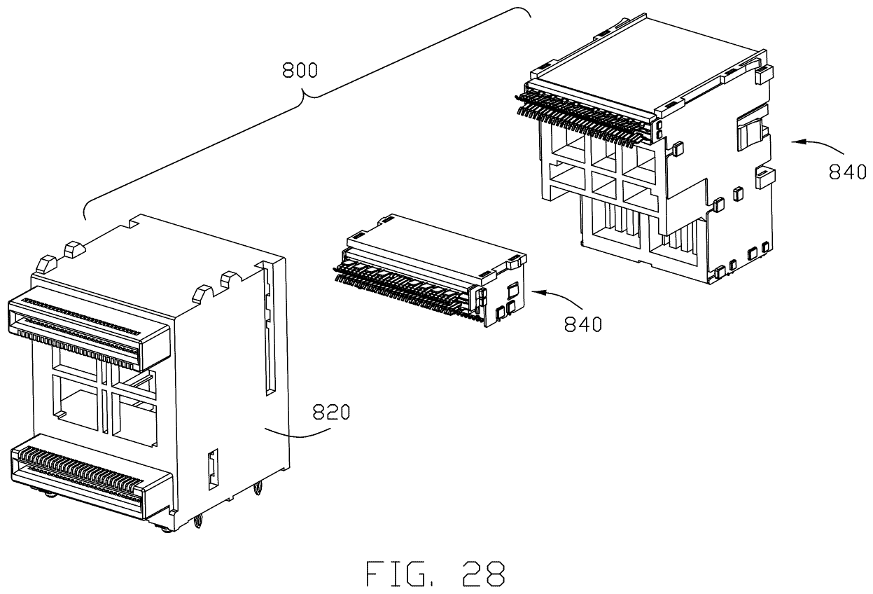

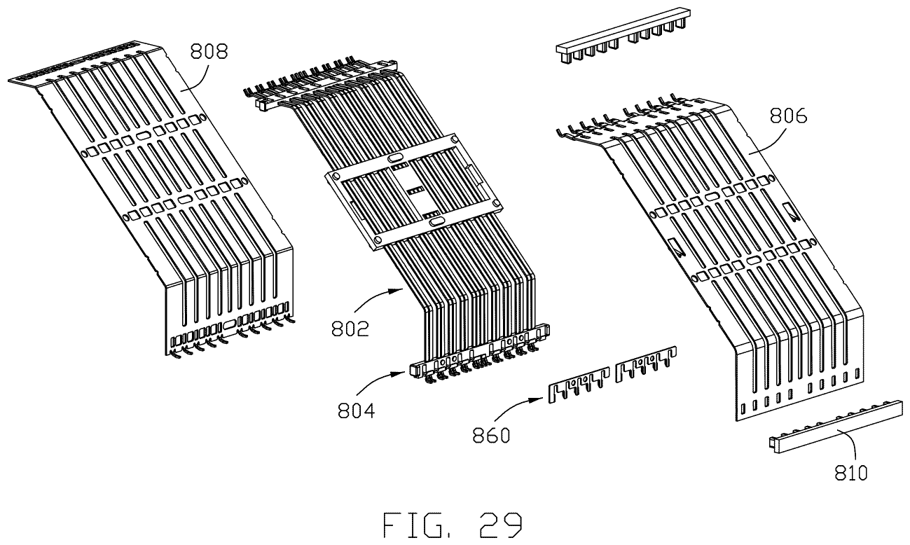

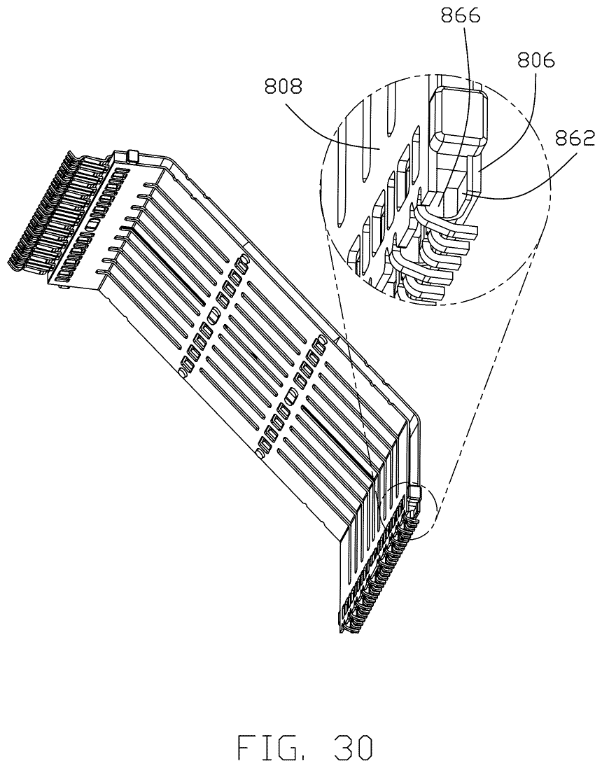

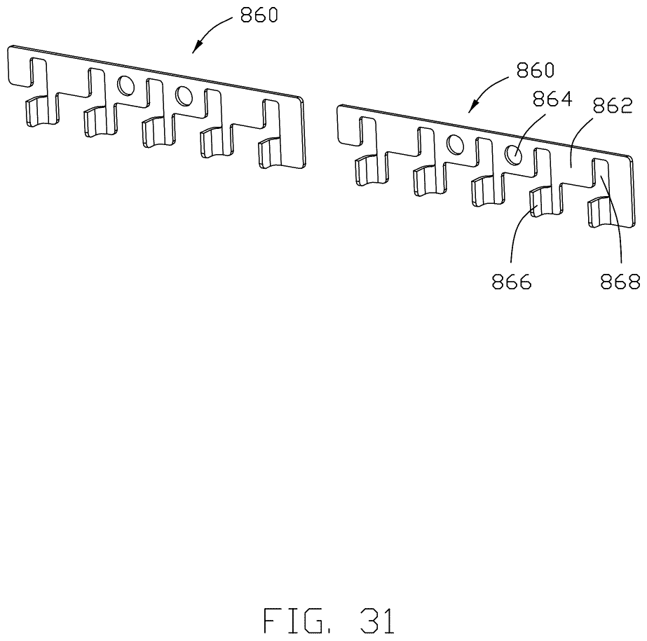

FIGS. 28-31 show yet another varied electrical connector 800 incorporating contact assemblies of the present invention. The electrical connector 800 comprises an insulative housing 820 and upper and lower contact modules 840 in the insulative housing 820. Each contact module 840 may include an upper assembly and a lower assembly designed in a similar way to those described above with reference to FIGS. 1-20. Specifically, the contact assembly shown in FIG. 29 includes a row of contacts 802, an insulator 804 secured to the row of contacts 802, an upper ground plate 806 and a lower ground plate 808 that surround the row of contacts 802, and a conductive element 810 electrically connecting to the upper and lower ground plates 806 and 808. The upper ground plate 806 may include a shield 860 which is sandwiched between the upper and lower ground plates 806 and 808 to provide noise isolation between high-speed differential signal pairs. The shield 860 has a main body 862, one or more locating holes 864 for receiving locating posts of the insulator 804, plural fingers 866 bent from the main body 862 and each to be located between the mounting portions of two adjacent pairs of differential signal contacts, and one or more openings 868 for the conductive element 810 to pass through. The shield 860 is firstly mounted to the insulator 804; then the upper and lower ground plates 806 and 808 are positioned in place, and the conductive element 810 passes through openings of the upper ground plate 806, the openings 868 of the shield 860, openings of the insulator 804, and openings of the lower ground plate 808 to rivet them together.

1. A contact assembly for an electrical connector, comprising:
a row of signal contacts having a plurality of contacting portions and a plurality of mounting portions;
an insulator secured to the row of signal contacts; and
an upper ground plate and a lower ground plate surrounding the row of signal contacts, at least one of the upper ground plate and the lower ground plate integrally forming a plurality of ground contacting portions aligned with the plurality of contacting portions of the row of signal contacts; wherein
each of the upper ground plate and the lower ground plate integrally has a plurality of ground mounting portions; and
the plurality of ground mounting portions of one of the upper ground plate and the lower ground plate contact the other one of the upper ground plate and the lower ground plate, and the plurality ground mounting portions of the other one of the upper ground plate and the lower ground plate are aligned with the plurality of mounting portions of the row of signal contacts.

2. The contact assembly as claimed in claim 1, wherein the plurality of ground mounting portions of the lower ground plate are aligned with the plurality of mounting portions of the row of signal contacts, and the plurality of ground mounting portions of the upper ground plate contact the lower ground plate.

3. The contact assembly as claimed in claim 2, wherein the plurality of ground mounting portions of the upper ground plate contact the plurality of ground mounting portions of the lower ground plate.

4. The contact assembly as claimed in claim 2, wherein each of the signal contacts has an intermediate portion between the contacting portion and the mounting portion, and the intermediate portion includes a horizontal section connected to the contacting portion and an inclined section connecting the horizontal section and the mounting portion.

5. The contact assembly as claimed in claim 4, wherein each of the upper ground plate and the lower ground plate has a horizontal portion and an inclined portion facing to the horizontal section and the inclined section of the signal contacts.

6. The contact assembly as claimed in claim 5, wherein the plurality of ground mounting portions of the upper ground plate contact an inclined section of the lower ground plate.

7. The contact assembly as claimed in claim 1, wherein the plurality of ground mounting portions of the upper ground plate are aligned with the plurality of mounting portions of the row of signal contacts, and the plurality of ground mounting portions of the lower ground plate contact the upper ground plate.

8. The contact assembly as claimed in claim 7, wherein the plurality of ground mounting portions of the lower ground plate contact the plurality of ground mounting portions of the upper ground plate.

9. The contact assembly as claimed in claim 8, wherein each of the signal contacts has an intermediate portion between the contacting portion and the mounting portion, and the intermediate portion includes a horizontal section, a vertical section, and an intermediate inclined section.

10. The contact assembly as claimed in claim 9, wherein each of the upper ground plate and the lower ground plate have a horizontal portion, a vertical portion, and an intermediate inclined portion.

11. The contact assembly as claimed in claim 10, wherein the plurality of ground mounting portions of the lower ground plate contact a vertical section of the upper ground plate.

12. The contact assembly as claimed in claim 1, wherein the row of signal contacts includes pairs of differential signal contacts and side-band contacts, each of the plurality of ground contacting portions of the upper ground plate or the lower ground plate is located beside or between corresponding pairs of differential signal contacts.

13. The contact assembly as claimed in claim 1, wherein the upper ground plate and the lower ground plate are equidistantly spaced from and surround the row of signal contacts.

14. An electrical connector comprising:
an insulative housing; and
a contact assembly comprising:
a row of signal contacts having a plurality of contacting portions and a plurality of mounting portions;
an insulator secured to the row of signal contacts; and
an upper ground plate and a lower ground plate surrounding the row of signal contacts, at least one of the upper ground plate and the lower ground plate integrally forming a plurality of ground contacting portions aligned with the plurality of contacting portions of the row of signal contacts; wherein
each of the upper ground plate and the lower ground plate integrally has a plurality of ground mounting portions; and
the plurality of ground mounting portions of the upper ground plate contact the lower ground plate, and the plurality of ground mounting portions of the lower ground plate contact the upper ground plate.

15. The electrical connector as claimed in claim 14, wherein the plurality of ground mounting portions of the lower ground plate are aligned with the plurality of mounting portions of the row of signal contacts, and the plurality of ground mounting portions of the upper ground plate contact the plurality of ground mounting portions of the lower ground plate.

16. The electrical connector as claimed in claim 14, wherein the plurality of ground mounting portions of the upper ground plate are aligned with the plurality of mounting portions of the row of signal contacts, and the plurality of ground mounting portions of the lower ground plate contact the plurality of ground mounting portions of the upper ground plate.

17. An electrical connector comprising:
an insulative housing; and
a contact assembly received in the insulative housing, the contact assembly comprising:
a row of signal contacts having a plurality of contacting portions and a plurality of mounting portions;
an insulator secured to the row of signal contacts; and
an upper ground plate and a lower ground plate surrounding the row of signal contacts, at least one of the upper ground plate and the lower ground plate integrally forming a plurality of ground contacting portions aligned with the plurality of contacting portions of the row of signal contacts; wherein
each of the upper ground plate and the lower ground plate integrally has a plurality of ground mounting portions, some of the ground mounting portions are aligned with the plurality of mounting portions of the row of signal contacts; and
the remaining ground mounting portions of the plurality of ground mounting portions extend from one of the upper ground plate and the lower ground plate and contact the other one of the upper ground plate and the lower ground plate.

18. The electrical connector as claimed in claim 17, wherein the upper ground plate forms some of the plurality of ground contacting portions and the lower ground plate forms the remaining ground contacting portions.

19. The electrical connector as claimed in claim 17, wherein some of the ground mounting portions of the upper ground plate are aligned with the plurality of mounting portions of the row of signal contacts, and the remaining ground contacting portions of the upper ground plate contact the lower ground plate.

20. The electrical connector as claimed in claim 17, wherein some of the ground mounting portions of the lower ground plate are aligned with the plurality of mounting portions of the row of signal contacts, and the remaining ground contacting portions of the lower ground plate contact the upper ground plate.
